(19) United States
(12) Patent Application Publication
(10) Pub. No.: US 2015/0147989 A1
(43) Pub. Date: May 28, 2015

(54) Antenna System Utilizing Parallel RF Feeding

(71) Applicant: Richard Strnad, Plano, TX (US)

(72) Inventor: Richard Strnad, Plano, TX (US)

(21) Appl. No.: 14/550,938

(22) Filed: Nov. 22, 2014

Related U.S. Application Data
(60) Provisional application No. 61/963,087, filed on Nov. 22, 2013.

(51) Int. Cl. H01Q 11/02

(52) U.S. Cl. CPC H01Q 11/02
USPC 455/129; 343/731

(57) ABSTRACT

An antenna to transmit a wave signal may include a transmission line to transmit the wave signal, a plurality of first transmitting conductors connected to the transmission line. The first transmitting conductors may be substantially perpendicular to the transmission line and the first transmitting conductors may be substantially the same length.

### PRIORITY

The present invention claims priority under 35 USC section 119 based on a provisional application with a Ser. No. 61/963,087 which was filed on Nov. 22, 2013

### FIELD OF THE INVENTION

The invention relates to an antenna system that is utilizing parallel RF feeding of the radiating elements resulting in highly directional radiation pattern usable for wireless high power energy transport and for highly directional point to point communication.

### BACKGROUND

Before the electrical wire grid was popularized and established, intense interest was deployed toward the development of wireless transport of electrical energy over long distance. As of today all efforts to transport high electric power met with little success. However, the transport of low power RF waves used in communication systems has evolved with great success.

The first well-known antenna experiment was conducted by the German physicist Heinrich Rudolf Hertz (1857-1894). In 1887, he built a system to produce and detect radio waves. The original intention of his experiment was to demonstrate the existence of electromagnetic radiation. A few years later Guglielmo Marconi (1874-1937), an Italian inventor, developed and commercialized wireless technology by introducing a radiotelegraph system. His famous experiment was the transatlantic transmission from Poldhu, UK to St Johns, Newfoundland in Canada in 1901.

Today, booming development of wireless communication technologies rapidly raise demands for antennas in the multibillion market, and current applications including, at least, mobile phones, portable computers, Global Positioning Systems, digital TV and many other applications. All these electronic devices rely on electrical energy to power their circuits, and most of them require a communication channel to exchange information with certain host devices, computers or systems. Currently, batteries and wireless technologies are utilized for these purposes. However, in many cases, these solutions are inadequate. For example, running out of battery power in a laptop or a cell phone when a recharging procedure is missed is an unpleasant, but common event. It would be highly desirable if, when a laptop, cell phone, media player or other electronic device is located within a “hot spot”, a wireless router will not only transmit/receive information, but also recharge these devices. With such technology, these personal devices will not need manual recharging, and their batteries can be made smaller since they are recharged more frequently. Such a wireless energy transfer technology could also be used in other consumer and industrial applications, such as transferring power from a solar panel, wind mill outside a residential house to the inside without a cable through the construction wall or roof, powering devices or systems inside a sealed, pressured, or vacuum container of either air or liquid, powering and guiding a robot or a vehicle wirelessly. With millions of operational wind mills and solar power generating plants, wireless transfer of electrical energy from the source to grid would create a very large market for specialized antenna system and contiguous radio frequency (RF) amplifiers. In the medical field, implanted microelectronic devices could perform a variety of therapeutic, prosthetic, and diagnostic functions. The deep brain simulation device, for example, could be used to treat Parkinson's disease and tumors. Currently, a complex surgical procedure is required to replace depleted battery. Wireless energy transfer technology can eliminate the need for these costly replacements.

Therefore a need exists for method and design for energy distribution that is wire free but easy to deploy and configurable while may deliver sufficient power to be practical to power many household and industrial devices and to transport high power RF energy wirelessly from point to point.

### SUMMARY

The purpose of this application is to disclose a design of an anisotropic antenna producing quasi-collimated RF beam. With this antenna, uninterrupted point to point communication is feasible in addition to wireless transport of high power RF energy from point to point.

It is an object of this invention to apply RF energy to antenna radiators at multiple points and in parallel.

It is an object of this invention to deliver RF energy to antenna radiators at multiple points simultaneously by adjusting the physical lengths of RF energy delivery conductors.

It is an object of this invention to synchronize RF energy delivery to antenna conductors by incorporating electronic delay lines into conductors.

It is yet another object of this invention to connect RF power amplifiers directly to antenna radiators.

It is an object of this invention to divide antenna radiators in segments with each segment being powered independently.

It is an object of this invention to adjust separation distance of vertically spaced radiators for maximum efficiency.

It is yet another object of this invention to adjust antenna radiators length for optimum effectiveness independent of radiating frequency.

It is yet another object of this invention to apply RF signal to segmented Hertzian dipole in serial manner thus simulating travelling wave.
An antenna to transmit a wave signal may include a transmission line to transmit the wave signal and a plurality of first transmitting conductors connected to the transmission line The first transmitting conductors may be substantially perpendicular to the transmission line, and the first transmitting conductors are substantially the same length.
The wave signal may be a square wave signal.
The first transmitting conductors may be continuous connected.
The first transmitting conductors may be discontinuous.
The antenna may include a plurality of second transmitting conductors.
The second transmission conductors may be parallel to the first transmitting conductors.
The second transmitting conductors may be continuously connected.
The second transmitting conductors may be discontinuous.
The first transmitting conductor may be fed at multiple points with parallel signal delivery
The first transmitting conductors and the second transmitting conductors are fed in parallel
   11) as in claim 5, wherein the first transmitting conductors and the second transmitting conductors may be separated by a distance of d=λ/2.
The antenna includes a RF (radio frequency) amplifier may be connected to the first transmitting conductor.
The amplifier may include a synchronizing element connected to the RF amplifier to provide simultaneous signal delivery to the first transmitting conductors
The inverting and non inverting signals generated by the RF amplifier may be fed into the synchronizing element.
The antenna may include a processor to generate non-parallel delivery of the RF signal to the first transmitting conductors may be controlled by the processor and the analog signal may be digitized.
The Digitized signal may be applied progressively from the center and sequentially applied incrementally from the antenna center toward the ends of the antenna to eliminate reflected parasite signals.
   The space wave generated by vertically stacked antenna may be in the direction perpendicular to the lines of force thus forming the anisotropic

### BRIEF DESCRIPTION OF THE DRAWINGS

FIG. 1 illustrates an anisotropic antenna;

FIG. 2 illustrates a transmission line;

FIG. 3 illustrates a full-wave dipole antenna;

FIG. 4 illustrates a dipole antenna which is fed in parallel;

FIG. 5 illustrates a dipole antenna with segmented conductors;

FIG. 6 illustrates a transmission line, antenna radiators and conductors;

FIG. 7 illustrates a system as in FIG. 6 where the incoming signal is fed into complementary amplifiers;

FIG. 8 illustrates a segmented Herzian dipole antenna;

FIG. 9 illustrates the anisotropic character of the antenna;

### DETAILED DESCRIPTION

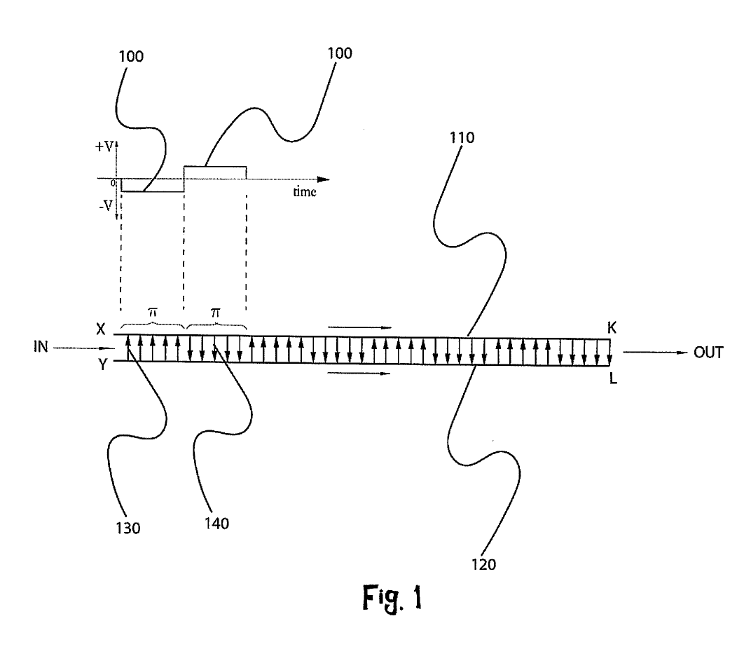

FIG. 1A frequent question about the anisotropic antenna is “how does it radiate?” A qualitative understanding of the radiation mechanism may be obtained by considering a square wave pulse train 100 applied to a two wire transmission line at points X & Y, consisting of conductors XK 110 & YL 120 as shown in FIG. 1. The movement of the charges creates a traveling wave current of magnitude I₀/2 along each of the wires together with positive lines of force 130 and negative lines of force 140. The square waves travel down the transmission line at a velocity of propagation determined by the line characteristics. The reflected traveling square wave, when combined with the incident traveling wave, forms in each wire a substantially pure standing wave pattern of square waves. In a two wire symmetrical transmission line, the current in a half-period of one wire is of the same magnitude but 180° out-of-phase from that in the corresponding half-period of the other wire. If the spacing for distance between the two conductors XY or KT, is very small, the fields radiated by the current of each wire are essentially cancelled by those of the other. The net result is an almost ideal non-radiating transmission line.

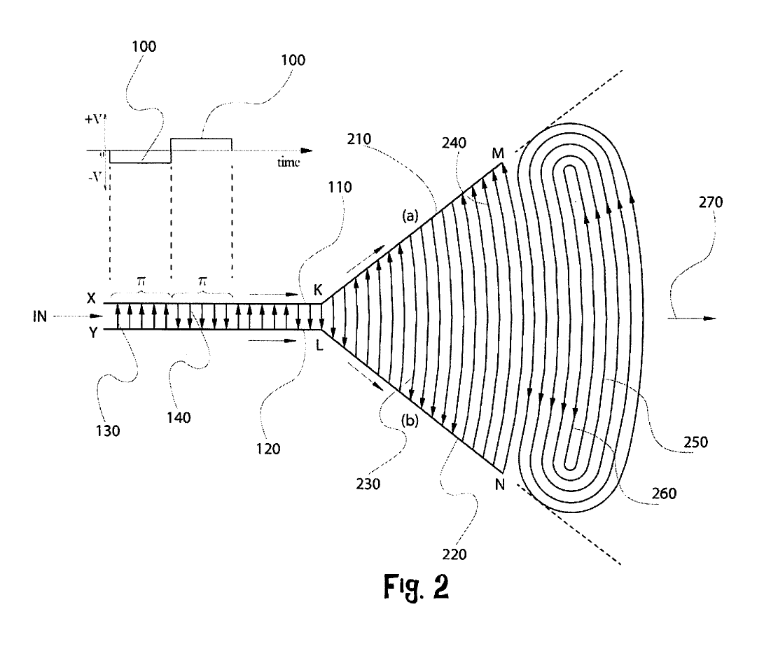

FIG. 2 shows the transmission line to flare (bend to an angled/inclined extension) at points K & L. In flared sections 210 & 220, the current is unaltered with positive lines of force 240 and 230 stretched, extending between the flared sections 210, 220). However in flared sections 210 & 220, the electric fields and currents no longer cancel each other out and result in the conversion from the traveling wave to the space wave. The positive lines of force 250 and negative lines of force 260 are joined and travel/extend outward in direction 270 from the ends of the flared sections 210, 220.

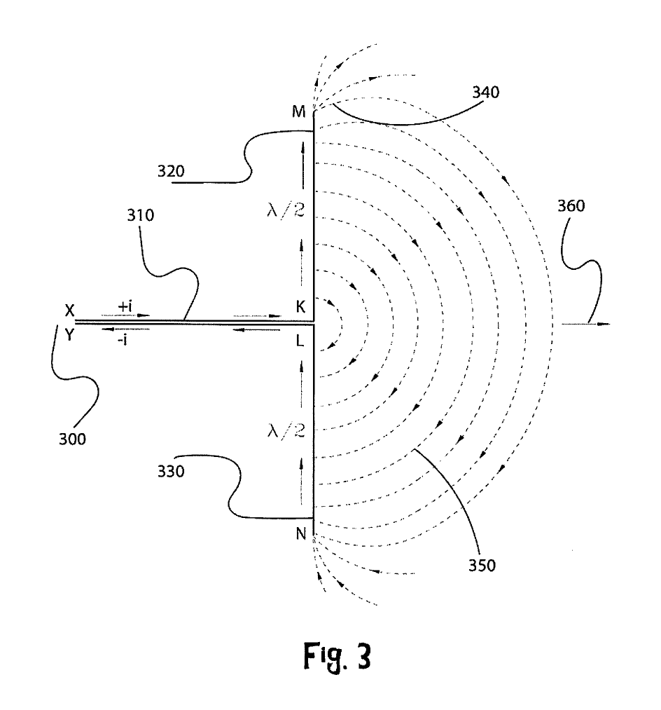

FIG. 3 shows the full-wave dipole antenna. The flared arms 320 & 330 of the transmission line 310 are positioned 90° or substantially at 90° from the transmission line 310. This antenna is called a standing wave antenna. The square wave signal is applied at points X&Y 300 and it travels to the ends where it is reflected back resulting with the voltage amplitude doubling at the ends M & N. The lines of force 350 are almost circular, however there is a fringing effect near the ends of antenna wires 320 & 330. The electric lines of force become crowded toward the ends and bulge out as illustrated by 340. The maximum radiation pattern of antenna is in the direction 360. According to Schelkunoff, the bulging end effect is only in the immediate vicinity of the ends and may be represented, therefore, by a lumped capacitance at the ends, added to the cap capacitance. The end effects effectively lengthen the antenna. The effective extension in the length of each arm may be calculated and it is described in antenna textbooks.

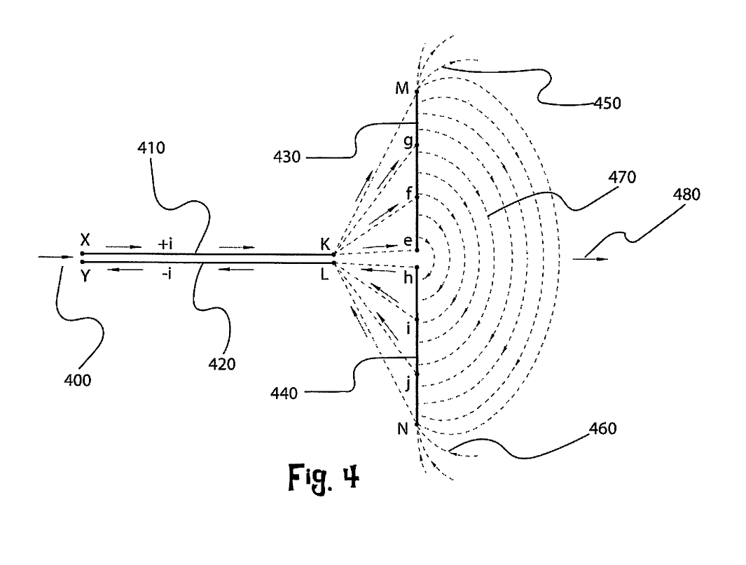

FIG. 4 illustrates a dipole antenna which is fed in parallel. Square wave signal 400 applied to transmission line 410 & 420 at points X & Y travels along transmission line until it reaches the end points K & L where the transmission line 410 & 420 is split into 4+4 conductors of equal length. Equal conductor distances Ke, Kf, Kg, KM and Kh, Ki, Kj & KN respectively guarantee equal signal time arrival to dipole antenna arms 430 & 440. The established lines of force 470 are similar to lines of force shown in FIG. 3 with crowded lines of force 450 & 460. However the end effects lengthening the antenna are not as pronounced. The maximum radiation pattern of antenna is in the direction 480.

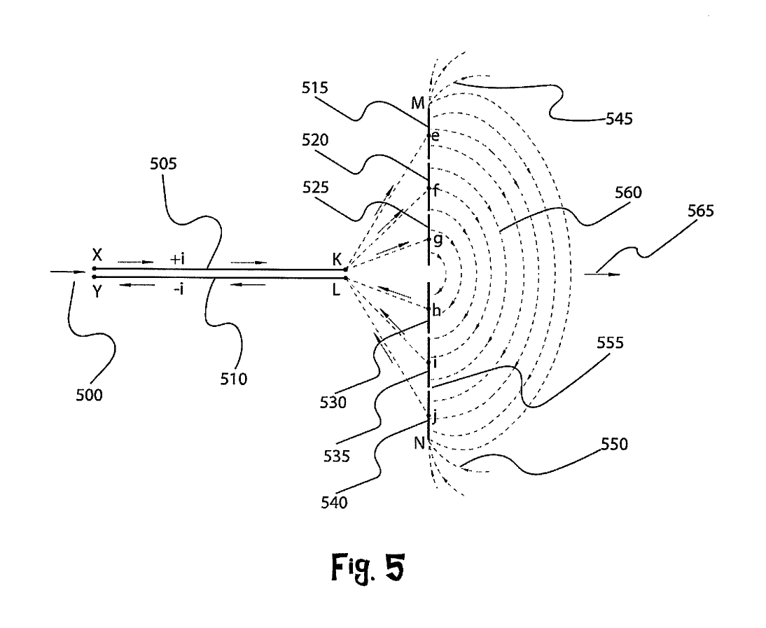

FIG. 5 depictes a dipole antenna with segmented conductors. Each half has three segments, 515, 520, 525, & 530, 535, 540. Each segment if includes wire conductors of equal physical length to deliver traveling signal 500 simultaneously. The distances between segments 555 are identical preferably small. The two end effects shown as disconnected bulging lines of force 545 & 550 can be represented by a lumped capacitance and they provide the need for lengthening the antenna. Finally, the converted traveling wave to space wave is shown by the direction arrow 565.

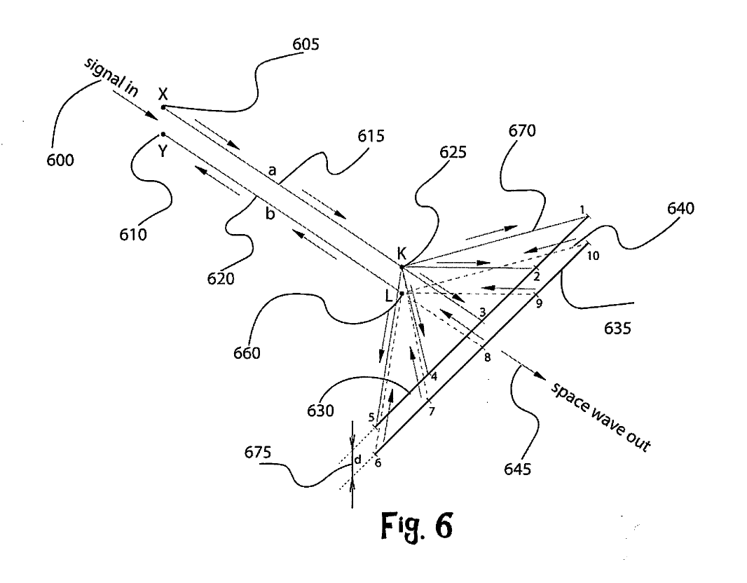

FIG. 6 RF signal 600 is applied to transmission line 615 & 620 at points 605 & 610 and travels until the RF signal 600 reaches points K 625 and L 660 where the RF signal 600 is branched out and delivered to antenna radiators 630 & 635 via conductors 670 of substantial equal physical lengths. The traveling waves of opposite polarities radiating from conductors 630 & 635 spread out in cylinder-like geometries having the antenna radiators at their centers. The times it takes these waves to reach distances r from the antenna sources are

$$\frac{r}{c} seconds$$

Where r=distance (meters)
c=velocity of light (=3×10⁸ meters/sec)

All points at a distance r from the antenna have the same phase. The wave-length being given by

$$λ = \frac{c}{f} = cT$$

where
c=velocity of light (=3×10⁸ meters/sec)
f=frequency (cycles/sec)
T=1/f=period (sec)
   The radiating systems of antenna conductors and equipotential cylindrical surfaces emanating from antenna conductors are of great importance. After the square wave signal 600 applied to transmission line reaches the antenna conductors 630 & 635, cylindrical waves of opposite polarities reach the opposing antenna conductors at times equal to T/2 when the conductor separation distance d 675 equals to λ/2. At this time the current between elements 630 & 635 starts to flow and the transition from traveling wave to space wave begins. The direction of emitting space wave leaving the antenna is shown as 645.

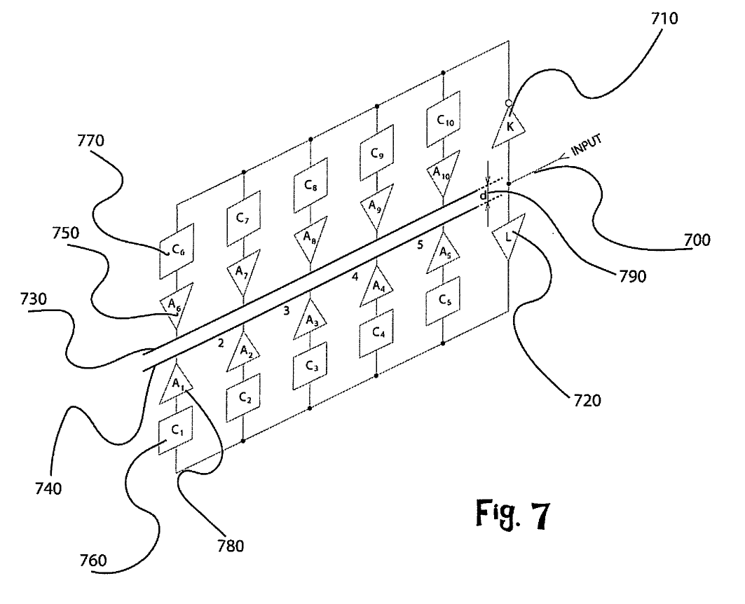

FIG. 7 illustrates a more elaborate system, where the incoming signal 700 is fed into complementary amplifiers 710 & 720. Amplifier 710 is of inverting type and the complimentary amplifier 720 is non inverting. The complimentary signals from amplifiers 710 & 720 enter controlling elements 760 & 770 where the timing is adjusted such, that the signals enter the arrays are of RF amplifiers 750 & 780 connected directly to antenna conductors 730 & 740 separated by distance d 790. The conversion process of traveling wave to space wave highlighted in this figure is identical to conversion process shown in FIG. 6.

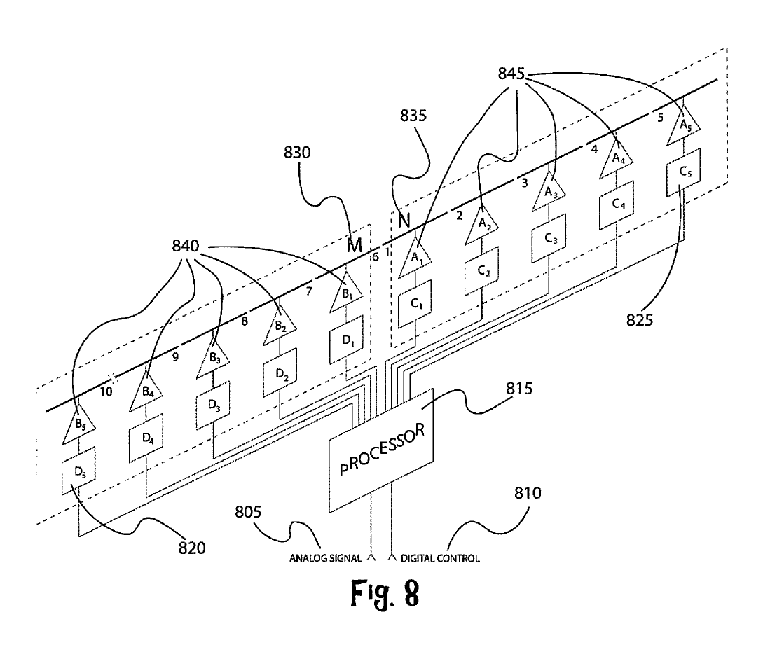

FIG. 8 FIG. 8 shows a segmented Herzian dipole antenna. There are two branches of the antenna: first branch is designated as 830 and the second branch is designated as 835. Each antenna half has 5 segments. RF energy to each segment is supplied by amplifiers 840 & 845 and each amplifier is connected to delay lines 820 & 825. The function of each delay line is to guarantee simultaneous signal deliveries to RF amplifiers and to antenna segments. Signal processor 815 is used to furnish two types of operating modes: one operating mode is delivering RF signals to antenna conductors in parallel and the second operating mode is delivering RF signal is serial per partes mode which may mean “in pieces, fragmented or portioned”. In the context it may mean a part of serial signal is giving instructions, another part of serial signal is giving information/data.

The operating character of the antenna in this mode resembles closely the Herzian dipole antenna, where the RF signals are first applied in a first time period at the antenna center. The next step the RF signals are applied in a second time period to the adjacent segments, shown as 2 & 7, the next step the RF signal is applied in a third time period to segments 3 & 8, the next step the RF signal is applied in a fourth time period to segments 4 & 9 and lastly the RF signals is applied in a fifth time period to segments 5 & 10. At this stage the process continues without signal reflections at both ends. There are two signal inputs 805 & 810 used to control the operation. The signal designated 805 delivers analog information to the antenna and the digital control signals 810 is providing the modes of operation.

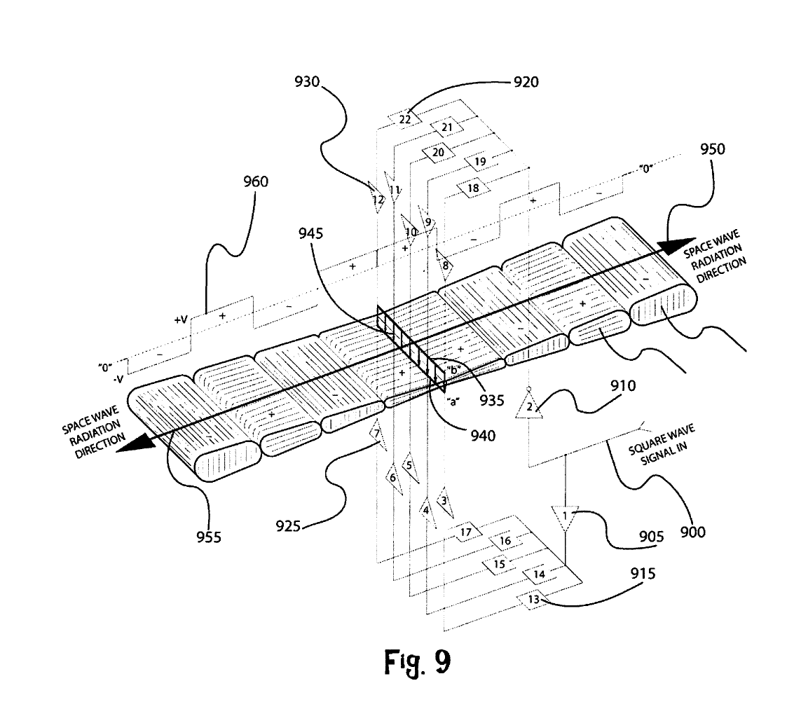

FIG. 9 illustrates the anisotropic character of the antenna. A signal 900 (in this case a square wave signal) is applied to the inverting and the non inverting amplifiers 905 & 910. The square wave signal is shown as 960. Outgoing signals from amplifiers 905 & 910 are fed into timing adjusting elements 915 & 920 which are connected to the RF amplifiers 925 & 930. The RF amplifiers 925 & 930 are connected to antenna elements 935 & 940. The lines of force 945 are between the antenna elements 935 & 940. The preferred direction of radiation is highlighted as 950 & 955. The emission of space waves is other directions are minimal.

What is claimed is:

1. An antenna to transmit a wave signal, comprising:
a transmission line to transmit the wave signal;
a plurality of first transmitting conductors connected to the transmission line;
wherein the first transmitting conductors are substantially perpendicular to the transmission line; and
wherein the first transmitting conductors are substantially the same length.

2. An antenna to transmit a wave signal as in claim 1, wherein the wave signal is a square wave signal.

3. An antenna to transmit a wave signal as in claim 1, wherein the first transmitting conductors are continuous connected.

4. An antenna to transmit a wave signal as in claim 1, wherein the first transmitting conductors are discontinuous.

5. An antenna to transmit a wave signal as in claim 1, wherein the antenna includes a plurality of second transmitting conductors.

6. An antenna to transmit a wave signal as in claim 5, wherein the second transmission conductors are parallel to the first transmitting conductors.

7. An antenna to transmit a wave signal as in claim 5, wherein the second transmitting conductors are continuously connected.

8. An antenna to transmit a wave signal as in claim 5, wherein the second transmitting conductors are discontinuous.

9. An antenna to transmit a wave signal as in claim 1, wherein the first transmitting conductor is fed at multiple points with parallel signal delivery

10. An antenna to transmit a wave signal as in claim 5, wherein the first transmitting conductors and the second transmitting conductors are fed in parallel

11. An antenna to transmit a wave signal as in claim 5, wherein the first transmitting conductors and the second transmitting conductors are separated by a distance of d=λ/2.

12. An antenna to transmit a wave signal as in claim 1, wherein the antenna includes a RF (radio frequency) amplifier connected to the first transmitting conductor.

13. An antenna to transmit a wave signal as in claim 12, wherein the amplifier includes a synchronizing element connected to the RF amplifier to provide simultaneous signal delivery to the first transmitting conductors

14. An antenna to transmit a wave signal as in claim 13, wherein inverting and non inverting signals generated by the RF amplifier are fed into the synchronizing element.

15. An antenna to transmit a wave signal as in claim 1, wherein the antenna includes a processor to generate non-parallel delivery of the RF signal to the first transmitting conductors may be controlled by the processor and the analog signal may be digitized.

16. An antenna to transmit a wave signal as in claim 15, wherein the Digitized signal may be applied progressively from the center and sequentially applied incrementally from the antenna center toward the ends of the antenna to eliminate reflected parasite signals.

17. An antenna to transmit a wave signal as in claim 6 wherein the space wave generated by vertically stacked antenna is in the direction perpendicular to the lines of force thus forming the anisotropic properties with potential antenna providing coherent and collinear space wave.
